(19) United States
(12) Patent Application Publication
(10) Pub. No.: US 2007/0146210 A1
(43) Pub. Date: Jun. 28, 2007

(54) Antenna array

(75) Inventor: Achim Hilgers, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,177

(22) PCT Filed: Feb. 22, 2005
(86) PCT No.: PCT/IB05/50634

§ 371 Date: Aug. 21, 2006

(30) Foreign Application Priority Data
Feb. 25, 2004 (EP) 04100736.0

(51) Int. Cl. H01Q 1/24

(52) U.S. Cl. 343/702

(57) ABSTRACT

An antenna array for the operation in two ranges of application (29,31) comprising a first and a second antenna (3,5) with which the positions of the resonant frequencies are different from each other, wherein these resonant frequencies lie between the two ranges of application (29,31).

The invention relates to an antenna array, particularly for mobile telecommunications, comprising a first and a second antenna.

An antenna array that has a first and a second antenna is known from U.S. Pat. No. 6,426,723. The two antennas are arranged above a printed circuit board. These two antennas are of the PIFA type, planar inverted F antennas. In the example of embodiment described in this document, these antennas are tuned to the PCS frequency band 1850-1990 MHz. For providing a polarization diversity, the antennas are arranged perpendicular to each other. This antenna array is provided for the application in a laptop computer. The antennas shown have the dimensions 7×30×10 mm³ and 10×27×10 mm³.

Development is moving towards electronic devices becoming ever smaller. For this reason, a miniaturization of the components is aspired, particularly by the implementation of a compact antenna unit. The size of the antenna or the antennas respectively, is of great importance specially for the application in mobile telecommunications.

It is an object of the invention to provide an antenna array, which has a compact structure and is suitable for application in mobile telecommunications.

The object of the invention is achieved by the features specified in the patent claims 1 and 7.

The antenna array in accordance with claim 1 has at least a first and a second antenna. These two antennas have a resonant frequency between a first and a second range of application. Furthermore, the positions of these resonant frequencies of the two antennas are different from each other. The two antennas of this antenna array can be operated both in the respective first and the second range of application. Thus, even in case of breakdown of one of the antennas further transmission and reception is possible. Different radiation fields can be provided by the simultaneous operation of both antennas.

Furthermore, the radiation field can be changed in a purpose-oriented way by a suitable selection of the arrangement of the antennas relative to each other. In some applications, particularly a parallel arrangement, may be a preferred arrangement for the utilization of available installation spaces.

By operating the antenna array with a suitable driver circuit comprising a power splitter, the power supplied to the antennas can be divided into specific dividing ratios. By splitting the total signal in two sub-signals, the radiation field of the antenna array can be varied in a purpose-oriented way.

By including an additional variable phase shifter in the driver circuit, the radiation field of the antenna array can be changed in a purpose-oriented way.

The phase offset can be modified in operation by a variable phase shifter. As a result, a switch-over can be made from an omnidirectional radiation field to a directional radiation field. The omnidirectional radiation field is advantageous for the receiving operation and a directional radiation field is advantageous for the transmitting operation. By orienting the radiation field, it is possible to use the applied power more efficiently as well as reduce the user's exposure to radiation.

Further advantageous measures are described in further dependent claims. In the following the invention will be described with reference to the following examples of embodiment.

In the drawings:

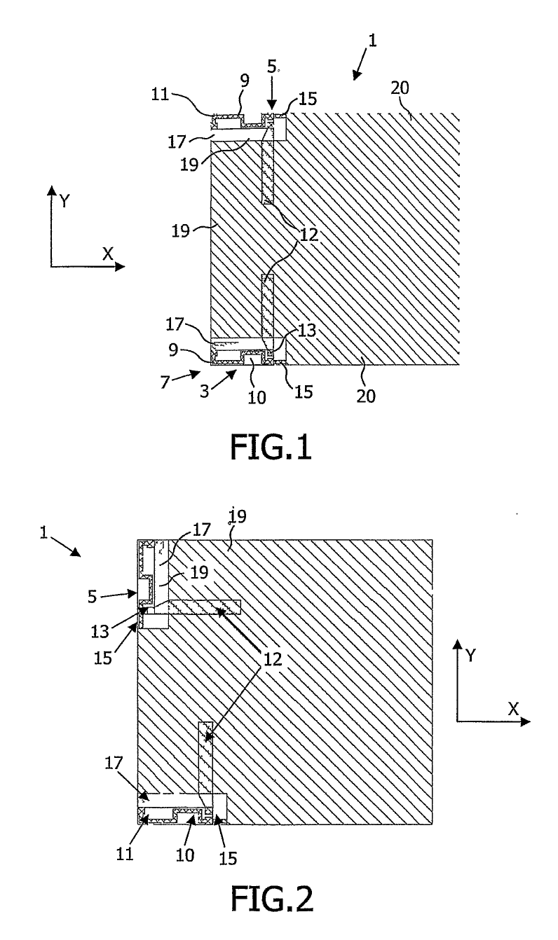

FIG. 1 shows an antenna array with two dielectric antennas in a parallel arrangement,

FIG. 2: shows an antenna array with two dielectric antennas in orthogonal arrangement,

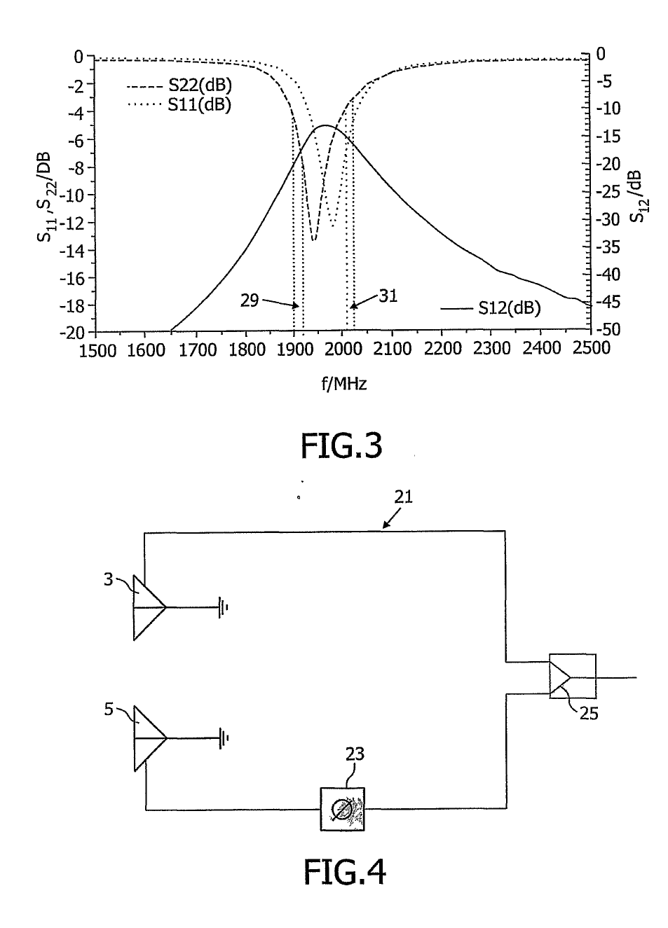

FIG. 3: gives a representation of the scattering parameters for a TD-SCDMA system,

FIG. 4: shows an electronic driver circuit,

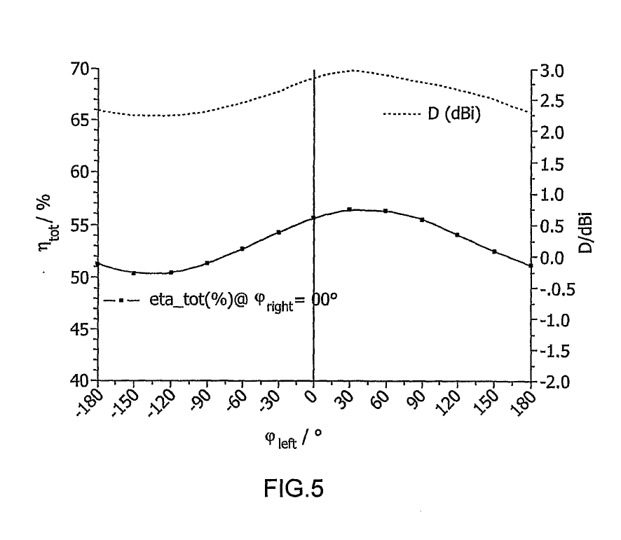

FIG. 5: gives a graphical representation of the efficiency (η) as well as the directivity (D) as a function of phase difference,

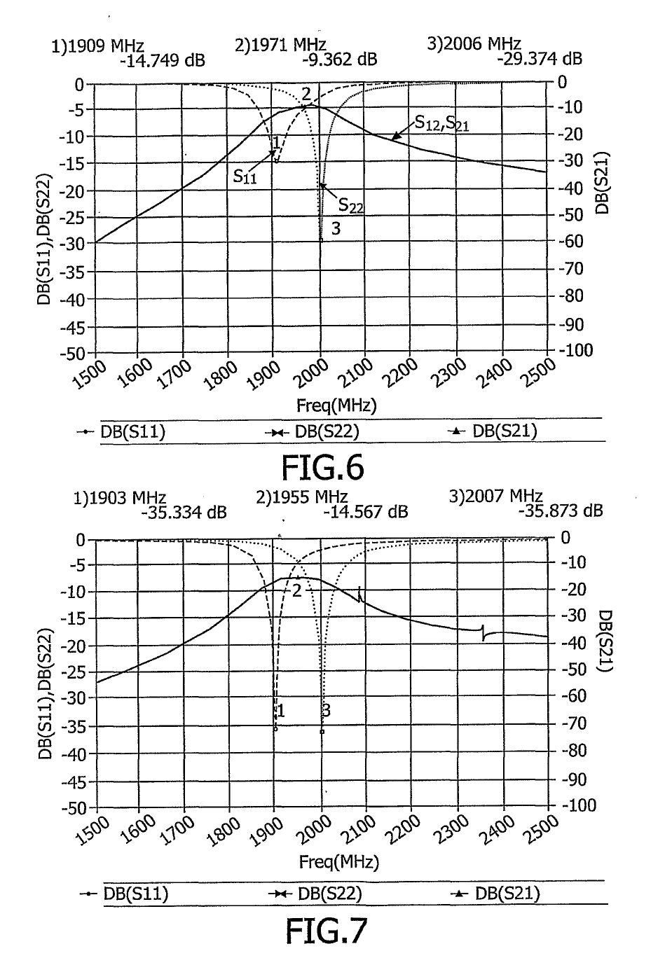

FIG. 6: gives a representation of the S-parameters with a parallel antenna arrangement,

FIG. 7: gives a representation of the S-parameters with an orthogonal antenna arrangement.

FIG. 1 shows an antenna array comprising a first antenna 3 and a second antenna 5. Dielectric block antennas 7 are provided as antennas 3,5, which dielectric block antennas are abbreviated to DBA. These dielectric antennas 7 comprise a substrate 10 of a dielectric material. In the examples of embodiment shown, a substrate having a dielectric constant of ∈ᵣ=20.6 was used. Typical materials are high-frequency-suited substrates with low losses and little temperature dependence of the high-frequency characteristics. Such materials are known as NP0-materials or what is called SL-material. Alternatively, HF-suitable plastics or ceramic-plastic mixtures can also be used by embedding ceramic particles in a polymer matrix.

The substrate 10 has a ground metallization 11 as resonant structure 9 and a high-frequency input 13. The resonant structure 9 is disposed on the underside of the substrate 10. The one end of the resonant structure 9 is contacted with the ground metallization 20 of the printed circuit board 19. The printed circuit board 19 is also denoted PCB (printed circuit board).

The other end of this resonant structure 9 is connected to a further printed wiring structure located on the PCB, which is denoted tuning stub 17. Thus, the tuning stub 17 forms an extension of the metallization of the resonant structure 9 of the dielectric block antenna 7. The total length of these two metallic printed lines, ground metallization 11 on the dielectric substrate 10 and tuning stub 17 define the lowest working frequency or resonant frequency respectively, of the antenna 3,5 depending upon the dielectric constants of the substrate 10 and the PCB 9. By reducing the length of the tuning stubs 17, the resonant frequency can be shifted to higher frequencies, if necessary. The reduction can be performed mechanically or by means of laser. With the tuning stub 17, identical DBAs can be tuned to different ranges of application, without having to modify the design of the antenna. Alternatively, specially designed antennas can also be used for the individual ranges of application.

In this example of embodiment, the substrates 10 used have the dimensions of 10.5×2.4×1 mm³ and the printed circuit board 19 has the dimensions of 90×35 mm². Other dimensions too are simply possible. If there is sufficient space (installation space) on the printed circuit board and/or if antennas are needed for frequency ranges beyond approximately 2 GHz, alternatively the entire resonant structure (as well as the HF-feed) can also be positioned directly on the PCB.

The high-frequency input 13 of the antenna 3,5 comprises a further metallization 13, which is likewise disposed on the underside of the substrate 10 and is connected typically to a 50Ω microstrip line as high-frequency line 13. The input structure of the antenna is generally designed such that it has an input impedance of 50Ω. Other input impedances can be implemented by corresponding modifications of the antenna design.

The resonance of the antenna 3,5 is activated by a capacitive coupling between the high-frequency input 13 and the resonant structure 9. By varying the distance between the 50Ω input 13 and the resonant metallization 11, the impedance matching of the antenna 3,5 can be set in a purpose-oriented way. If the distance is increased, that is, the capacitive coupling is reduced, then the coupling to the resonator decreases and a subcritical coupling results. With a reduction of the respective distance and thus enlargement of the capacitive coupling, the resonator can be coupled supercritically.

In this antenna array, the two antennas are arranged parallel to each other. Deviating from the array represented in FIG. 1, the antennas in the parallel arrangement can also be arranged offset to each other near the edges of the PCB.

Such an array presents itself particularly in systems, which are not held in hand during transmitting and receiving operations, but are, for example, placed on a table.

In FIG. 2 an orthogonal arrangement of the antennas on a PCB is shown. The structure of the antennas used does not differ from the antennas described with reference to FIG. 1. The different radiation behavior of an antenna array in an orthogonal arrangement in comparison to an antenna array in a parallel arrangement is described with reference to FIGS. 7 and 8.

The antenna arrays 1 represented in FIGS. 1 and 2 can be operated with a driver circuit 21 represented in FIG. 4. This driver circuit 21 can also be used for the operation of other antenna arrays.

In FIG. 3 are described in more detail by way of example the scattering parameters of an antenna array, which is designed for the TD-SCDMA system. An antenna array in an orthogonal arrangement of the antennas 3,5 was used in accordance with FIG. 2.

The scattering parameter S₁₁ always refers to the antenna 3 and the scattering parameter S₂₂ always refers to the antenna 5. Furthermore, the S₁₂-parameter is entered in this representation, which S₁₂-parameter describes the transmission behavior of the two antennas 3 and 5. Instead of transmission one can also speak of isolation. If the isolation is 100%, then the transmission is 0%. In this example of embodiment, the maximum transmission is approximately −15 dB. The transmission should not be below −20 dB and above −4 dB.

In this example of embodiment, the first range of application 29 is in the 1900-1920 MHz range and the second range of application 31 is in the 2010-2025 MHz range. The two antennas 3,5 of the antenna array 1 are tuned in such a way that their resonant frequencies lie between the first and the second range of application 29, 31. This tuning of an antenna array in such a manner that the resonant frequencies lie between the ranges of application, can be transferred in the same way to other systems or networks. The maximum power consumption generally corresponds to a minimum of the S_{11,22}-parameter. A transmitting and receiving operation of the antenna array is ensured by both antennas. Even if either of the antennas 3,5 fails, transmitting and receiving remains possible, since both antennas in both ranges of application have sufficient impedance matching. This is a type of emergency operation with reduced receiving and transmitting power of the antenna array.

In addition, the S-parameter of the antennas 3,5 within the ranges of application (frequency bands) is less, −2 dB, which as a rule corresponds to a power consumption of the antennas 3,5 of more than 30% of the power fed through the high-frequency input 13. By tuning the antennas 3,5 in such a way that the minimum of the respective S-parameter lies between the first and the second frequency band, it is possible to operate each of these antennas 3,5 about equally well in both frequency bands.

FIG. 4 shows an exemplary electronic driver circuit 21 for an antenna array 1 according to the invention, comprising two separate antennas 3,5. This driver circuit 21 comprises a power splitter 25 and a phase shifter 23. By means of this driver circuit 21 both antennas 3,5 can be controlled at the same time. With the use of an antenna array with more than two antennas the circuit must be adapted accordingly. With n antennas this adaptation may be made by a power splitter, which divides into n-channels. For providing a phase shift of all n-channels to each other, it is sufficient to provide n−1 channels with a phase shifter.

In the driver circuit 21 shown a high-frequency signal is divided by the power splitter 25 in two equally strong sub-signals. Deviating from this, a different weighting of the signals is also possible. One of the signals resulting from the division is directly led to the first antenna 3. The second signal is led to the second antenna 5 via a phase shifter 23. Ideally, the phase shifter 23 is a variable phase shifter, which sets a certain phase position between 0-360° depending on a control signal. Thus, either of the two antennas can always be controlled by a signal that is phase shifted by 0-360° relative to the signal of the other antenna.

If only a certain phase position of the antennas 3, 5 relative to each other is needed, then the appropriate phase position can be set by a high-frequency line (as a rule 50Ω) of certain length. The electrical length of this high-frequency line causes a fixed phase shift to occur. In case more than one fixed phase shift are needed, several high-frequency printed lines of different electrical lengths can be connected via a switch matrix, for example, in the form of PIN diodes. Depending on the necessary phase position, the switching position can be selected by a suitable control signal, which activates the appropriate high-frequency line. In a further execution, the high-frequency lines of different lengths can also be implemented by active and/or passive electrical components.

With the antenna array 1 together with the driver circuit 21, represented in FIG. 4, an actively controllable antenna array is provided. By changing the input signals regarding phase and the proportion of the respective power fed into the antennas 3,5 and by the positioning of the antennas 3,5 relative to each other, the typical radiation characteristics, such as directivity and efficiency, are modified.

Even without additional wiring according to the invention, the antenna array represented in FIG. 1, has enormous advantages over broadband single-antenna solutions, since the use of two narrow-band DBAs provides a certain filter effect of about 10 dB between the transmitting and the receiving band (for example with GDSM900, 1800, 1900), which otherwise has to be realized by additional filter components, such as a duplex filter or switch. It is ensured by the filter effect that transmitting and receiving signal are separated from each other.

Although the distance between the individual antennas in the orthogonal antenna arrangement of FIG. 2 is reduced (in comparison to the parallel arrangement), the transmission is reduced from −9.36 dB to −14.57 dB, however. Therefore, the defined position/positioning of the two antennas 3,5 relative to each other can be utilized to adjust the transmission in a purpose-oriented way.

In addition to the above-mentioned modification of the transmission characteristics of an antenna array, moreover, the radiation characteristic can also be influenced by the position of the antennas relative to each other. It has then appeared that the following properties can be established for a TD-SCDMA antenna array mentioned above.

With separate control of the individual antennas, the orthogonal antenna arrangement leads to the fact that the antenna 3 that is arranged parallel to the longer side of the printed circuit board, radiates to an increased extent in the negative y-half space. The antenna 5, which is arranged parallel to the shorter side of the PCB, in contrast radiates to an increased extent in the positive y-half space. Furthermore, a change of the polarization of about 90° can be established.

With separate control of the individual antennas, the parallel antenna arrangement leads to the fact that the antenna that is arranged parallel to the longer side of the printed circuit board, also radiates to an increased extent in the negative y-half space. The antenna 5, which is also arranged parallel to the longer side of the PCB, however, radiates to an increased extent in the positive and negative z-half space. Furthermore, a change of the polarization of about 90° can also be established.

In addition to the active setting of the desired maximum radiation direction, particularly the rotation of the radiation polarization can be of use. This effect can be utilized, for example, in order to use diversity systems (polarisation diversity, in concrete terms here) in mobile phone devices.

In the following, the radiation performance of the orthogonally aligned antenna arrangement with different phase positions in accordance with FIG. 2, is given in further detail. For this purpose a driver circuit 21 in accordance with FIG. 4 is used. The power is divided in two equal parts by the power splitter 25. The phase position of the high-frequency input signals supplied to the antennas is varied. Furthermore, only a phase difference between the two input signals of the antennas is discussed. The description of the radiation field refers to an exemplary frequency of 1955 MHz. But in principle the observed characteristics can also be adapted to other frequencies.

The following radiation fields go with the different phase positions.
Δφ=0°: increased radiation in the reverse space (negative. X-axis, approximately rotationally symmetrical to the X-axis)
Δφ=60°: conventional dipole-like radiating behavior
Δφ=150°: strongly directive radiating behavior (positive X-axis, approximately rotationally symmetrical to the X-axis)
Δφ=−90°: stronger radiation in the negative y-half space, approximately rotationally symmetrical to the Y-axis

Thus, the setting of a phase offset can be used in a purpose-oriented way to provide a radiation field with a special orientation and radiation distribution.

Referring to the two phase positions Δφ=60° and Δφ=150°, a mobile telephone device can, for example, be designed having, on the one hand, an omnidirectional radiation pattern for receiving (Rx with Δφ=60°) and, on the other hand a directive for transmitting (Tx with Δφ=150°). Accordingly, this would substantially reduce the radiation load of the user.

After the discussion of the influence of the arrangement of the antennas on the radiation behavior, the influence of the phase offset on the total efficiency of the antenna array with simultaneous operation of the antennas 3,5 tuned to different resonant frequencies in accordance with FIG. 7, is given below with reference to FIG. 5. With this study the orthogonal arrangement in accordance with FIG. 2 is the basis, while the result can also be transferred to an antenna array with a parallel antenna arrangement.

FIG. 5 shows the efficiency as well as the directivity with the orthogonal arrangement of the antennas 3,5. The efficiency η and the directivity D are directly linked to each other by the antenna gain G and the following applies: G=η·D.

The efficiency and the directivity are represented as a function of the phase shift between the input signals of the two antennas of the antenna array. The phase position of the signal of the first antenna 3 is then constant. At the same time the phase position of the signal of a second antenna is varied by ±180° in stages of 30° (or reverse). The set phase is plotted on the horizontal axis. On the left vertical axis the efficiency is plotted in % and on the right vertical axis the directivity is plotted in comparison to an isotropic emitter. The upper dotted curve shows the measured values of the directivity and the lower curve represents the efficiency. A sinusoidal course of the efficiency and the directivity can be clearly observed. An optimal efficiency with simultaneous maximum directivity, which leads to a maximization of the antenna gain, is found in case of an absolute phase difference of about 30° between the input signals of the two antennas. The efficiency is then about 5% better than with the worst phase difference.

In the FIGS. 6 and 7 are shown the scattering parameters of an antenna array with a parallel or orthogonal arrangement of the antennas relative to each other.

As already described above, the orientation of the antennas 3,5 on the PCB 19 changes, among other things, the isolation between the two antennas 3,5 as well as the fundamental radiation pattern. Depending on the application (for example, frequency range) and other constraints, like, for example, size of the device/printed circuit board, the radiation characteristics can be modified and optimized by suitable selection of the antenna array even without additional wiring.

In FIGS. 6 and 7 the scattering parameters, also denoted S-parameters, are represented of antenna arrays 1, which are designed for TD-SCDMA. FIG. 6 refers to an antenna array with antennas arranged parallel to each other and FIG. 7 refers to an antenna array with antennas arranged orthogonal to each other. By modifying the length of the tuning stubs 17 the antennas 3, 5 have been matched in such a way that the antenna 3 covers the TD-SCDMA transmitting frequency band, 1900 MHz-1920 MHz and the antenna 5 covers the TD-SCDMA receiving frequency band, 2010 MHz-20250 MHz, or vice versa.

From this comparison it is to be seen that the maximum transmission reaches a value of −9.36 dB with the parallel arrangement and reaches a maximum value of −14.57 dB with the orthogonal arrangement.

### REFERENCE SYMBOL LIST

1 Antenna array
3 First antenna
5 Second antenna
7 Dielectric antenna
9 Resonant structure
10 Substrate
11 Ground metallization
12 High-frequency line
13 High-frequency input
15 Ground connection
17 Stub
19 Printed circuit board, PCB
20 Ground metallization
21 Driver circuit
23 Phase shifter
25 Power splitter
27 Maximum power consumption
29 First range of application
31 Second range of application

1. An antenna array (1) for operation in two ranges of application (29,31) comprising a first and second antenna (3,5) with which the positions of the resonant frequencies are different from each other, while these resonant frequencies lie between the two ranges of application (29,31).

2. An antenna array as claimed in claim 1, characterized in that the transmission in the ranges of application (29, 31) lies in the range from −20 dB to −4 dB.

3. An antenna array as claimed in claim 1, characterized in that the transmission in the ranges of application (29, 31) lies in the range from −20 dB to −6 dB.

4. An antenna array as claimed in claim 1, characterized in that the transmission in the ranges of application (29, 31) lies in the range from −20 dB to −10 dB.

5. An antenna array as claimed in claim 1, characterized in that the two ranges of application (29, 31) have a distance of less than 200 MHz.

6. An antenna array as claimed in claim 1, characterized in that the reflection of both antennas (3,5) within the respective ranges of application is less than −2 dB.

7. An antenna array, comprising a first (3) and a second antenna (5), which are arranged parallel to each other.

8. An antenna array as claimed in claim 1, comprising a first antenna (3) and a second antenna (5) and a driver circuit (21) comprising a power splitter (25) and preferably a variable phase shifter (23).

9. An antenna array as claimed in claim 1, characterized in that the first (3) and the second antenna (5) are dielectric block antennas (7).

10. An antenna array as claimed in claim 1, characterized in that the first (3) and the second antenna (5) are arranged as surface mounted devices on a surface of a printed circuit board (19).

11. An antenna array as claimed in claim 1, characterized in that the antennas (3,5) are mounted at a distance of maximum 10 cm and minimum of 2 cm from each other.

12. A telecommunication device comprising an antenna array (1) in accordance claim 1.

13. A method for the operation of an antenna array in accordance with claim 1, wherein both antennas (3,5) can be operated at the same time and a division of the power that is supplied to the respective antennas (3,5) is executed by means of a power splitter (25).

14. A method for the operation of an antenna array (1) in accordance claim 1 wherein the two antennas (3,5) are operated with phase offset depending upon the desired radiation pattern.
